(19) United States
(12) Patent Application Publication
(10) Pub. No.: US 2011/0055820 A1
(43) Pub. Date: Mar. 3, 2011

(54) SOFTWARE VERSION-UP/ADDITION MANAGING APPARATUS, MULTIFUNCTION APPARATUS, SOFTWARE VERSION-UP/ADDITION MANAGING METHOD AND COMPUTER READABLE MEDIUM

(75) Inventor: Tomohisa ISHIKAWA, Kanagawa (JP)

(73) Assignee: FUJI XEROX CO., LTD., Tokyo (JP)

(21) Appl. No.: 12/726,839

(22) Filed: Mar. 18, 2010

(30) Foreign Application Priority Data
Sep. 2, 2009 (JP) 2009-202249

(51) Int. Cl. G06F 9/44

(52) U.S. Cl. 717/170

(57) ABSTRACT

A software version-up/addition managing apparatus includes: a version-up/addition accepting section accepting an instruction of certain processing of a software; a dependency relation extracting section extracting a dependent software; a reference value associating section associating reference values with the software, and the extracted dependent software, respectively; a reference value changing section that, when the certain processing is instructed as to the software or the dependent software or when the software or the dependent software is extracted as a dependent software of another software, increments the reference value of the software or the extracted dependent software, and when stop of the certain processing is instructed, decrements the reference value of the software or the extracted dependent software; and a stop determination section determining based on the reference value, when the instruction of the stop is accepted, whether or not the instruction of the stop is to be executed.

### CROSS-REFERENCE TO RELATED APPLICATIONS

This application is based on and claims priority under 35 USC 119 from Japanese Patent Application No. 2009-202249 filed on Sep. 2, 2009.

### BACKGROUND

1. Technical Field

The present invention relates to a software version-up/addition managing apparatus, a multifunction apparatus, a software version-up/addition managing method and a computer readable medium.

2. Related Art

In accordance with the tendency of the multifunction of a software to be mounted on a multifunction apparatus etc. having functions such as a scanner, a printing apparatus, a copying machine, a facsimile machine, there have been proposed an apparatus and a program for performing the version-up of a software on a module unit basis. Further, at the time of performing the version-up or addition of a software on the module unit basis, the software can be customized by performing the version-up or addition of the software at every user.

### SUMMARY

According to an aspect of the invention, a software version-up/addition managing apparatus includes a version-up/addition accepting section, a dependency relation extracting section, a reference value associating section, a reference value changing section and a stop determination section. The version-up/addition accepting section accepts an instruction of version-up processing or addition processing of a software. The dependency relation extracting section extracts a dependent software with which the software to be subjected to the version-up processing or the addition processing has a dependency relation. The reference value associating section associates reference values with (i) the software of which the version-up/addition accepting section accepts the instruction of the version-up processing or the addition processing, and (ii) the dependent software extracted by the dependency relation extracting section, respectively. The reference value changing section, when the version-up processing or the addition processing is instructed as to the software or the dependent software or when the software or the dependent software is extracted as a dependent software of another software, increments the reference value of the software to be subjected to the version-up processing or the addition processing or the dependent software extracted by the dependency relation extracting section. The reference value changing section, when stop of the version-up processing or the addition processing is instructed, decrements the reference value of the software to be subjected to the version-up processing or the addition processing or the dependent software extracted by the dependency relation extracting section. The stop determination section determines based on the reference value, when the instruction of the stop of the version-up processing or the addition processing is accepted, whether or not the instruction of the stop is to be executed.

### BRIEF DESCRIPTION OF THE DRAWINGS

Exemplary embodiment(s) of the present invention will be described in detail based on the following figures, wherein:

FIG. 1 is a diagram showing an example of the configuration of a software version-up/addition system to which a software version-up/addition managing apparatus according to an exemplary embodiment is applied;

FIG. 2 is a diagram showing an example of the configuration of the hardware of a computer constituting the software version-up/addition management apparatus according to the exemplary embodiment;

FIG. 3 is a functional block diagram of the software version-up/addition management apparatus according to the exemplary embodiment;

FIG. 4 is a flowchart showing an example of the operation of the software version-up/addition management apparatus according to the exemplary embodiment;

FIG. 5 is a diagram for explaining the flow of instructions and softwares in the case where a user instructs the version-up or addition of a software; and

FIGS. 6A to 6C are diagrams showing examples of management information lists managed by the software version-up/addition management apparatus in the case where a user instructs the version-up or addition of a software.

### DETAILED DESCRIPTION

Hereinafter, an exemplary embodiment for carrying out the invention will be explained according to drawings.

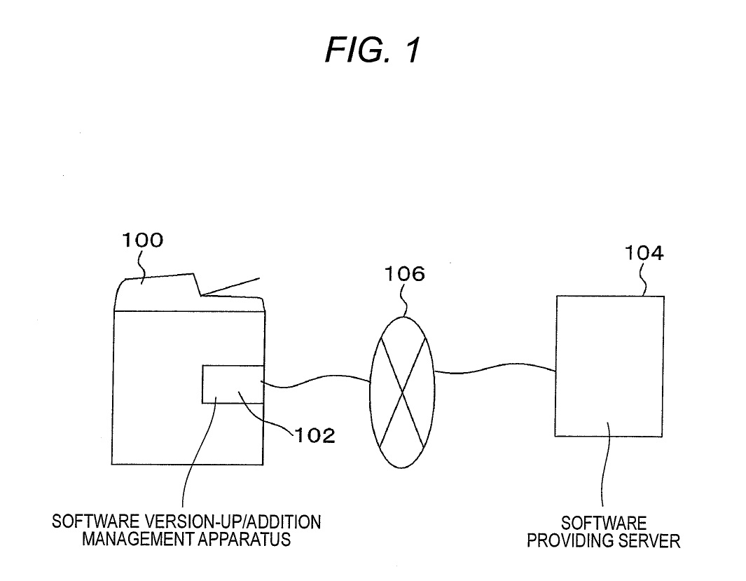

FIG. 1 is a diagram showing an example of the configuration of a software version-up/addition system to which the software version-up/addition managing apparatus according to the exemplary embodiment is applied. In FIG. 1, a multifunction apparatus 100 mounts thereon a software version-up/addition management apparatus 102 which is coupled to a software providing server 104 for providing software for version-up or addition via a communications 106 such as a network.

The multifunction apparatus 100 has functions such as a scanner, a printing apparatus, a copying machine, a facsimile machine. Each of these functions is realized by a software and a hardware on a module unit basis. Although the explanation is made as to the multifunction apparatus 100 as an example in this exemplary embodiment, the apparatus is not limited to the multifunction apparatus so long as the version-up or addition of a software can be performed on the module unit basis by plural users. The software version-up/addition management apparatus 102 will be explained later.

The software providing server 104 provides a software for performing the version-up or addition of the software of the multifunction apparatus 100 in accordance with the request from a user.

The communications 106 is configured by the network etc. as described above. To be concrete, the internet or the intranet etc. is used as the communications, preferable.

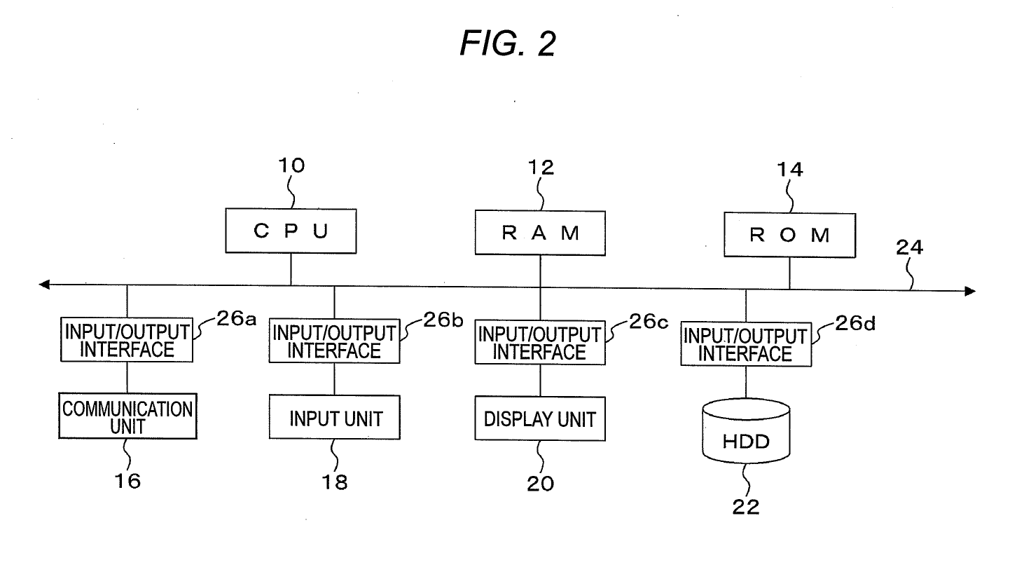

FIG. 2 is a diagram showing an example of the configuration of the hardware of a computer constituting the software version-up/addition management apparatus 102 according to the exemplary embodiment. In FIG. 2, the software version-up/addition management apparatus 102 is configured to include a central processing unit (for example, a CPU such as a microprocessor may be used, preferably) 10, a random access memory (RAM) 12, a read only memory (ROM) 14, a communication unit 16, an input unit 18, a display unit 20 and a hard disc drive (HDD) 22. These constituent elements are mutually coupled via a bus 24. The communication unit 16, the input unit 18, the display unit 20 and the hard disc drive 22 are coupled to the bus 24 via input/output interfaces 26a, 26b, 26c and 26d, respectively.

The CPU 10 controls the operations of various sections described later based on a control program stored in the RAM 12 or the ROM 14. The RAM 12 mainly acts as the work area of the CPU 10. The ROM 14 stores the control program such as BIOS and data used by the CPU 10.

The communication unit 16 is constituted by a suitable interface such as a USB (Universal Serial Bus) port, a network port, a radio communication port. The CPU 10 uses the communication unit in order to transmit/receive data to/from an external device via communications such as a network. Although a port coped with the communication such as an infrared ray communication port, a non-contact type IC card may be used as the radio communication port, the radio communication port used in the exemplary embodiment is not limited thereto. As an example of the data transmission and reception performed via the communication unit, the software is transmitted/received in order to perform the version-up or addition of the software of the multifunction apparatus 100. Further, as another example, the communication unit receives an instruction of the software version-up or addition processing transmitted from a portable terminal etc. by a user via the infrared ray communication port or the non-contact type IC card etc.

The input unit 18 is constituted by a key board, a pointing device or a touch panel etc. and is used for a user to input an operation instruction etc. The input unit 18 may also be used as an input panel for the multifunction apparatus 100.

The display unit 20 is constituted by a liquid crystal display panel or a touch panel etc. and displays the processing result of the CPU 10 such as the result of the software version-up or addition processing. The display unit 20 may also be used as the display panel of the multifunction apparatus 100.

The hard disc drive 22 serves as a storage unit and stores various kinds of data necessary for the processings described later. A nonvolatile memory such as an EEPROM may be used in place of the hard disc drive 22.

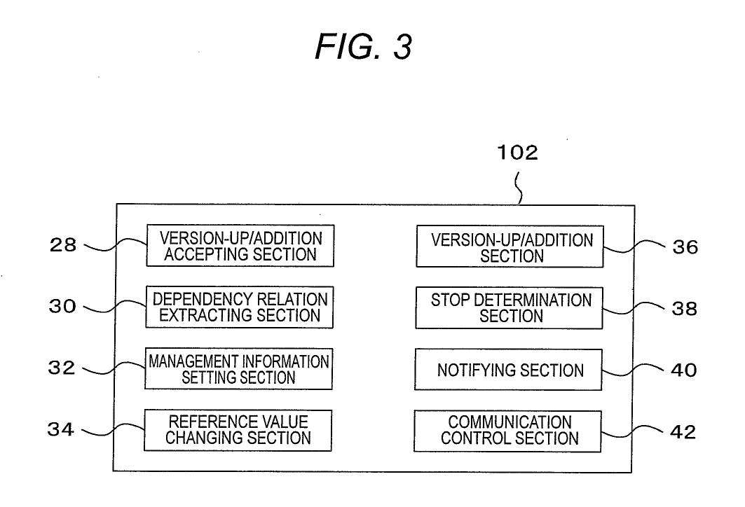

FIG. 3 shows a functional block diagram of the software version-up/addition management apparatus 102 according to the exemplary embodiment. In FIG. 3, the software version-up/addition management apparatus 102 is configured to include a version-up/addition accepting section 28, a dependency relation extracting section 30, a management information setting section 32, a reference value changing section 34, a version-up/addition section 36, a stop determination section 38, a notifying section 40 and a communication control section 42. These functions are realized by the CPU 10 and the program for controlling the processing operation of the CPU 10. A part of the aforesaid functions may be realized by a dedicated hardware (for example, ASIC).

The version-up/addition accepting section 28 accepts the instruction of the software version-up or addition processing from a user. In this case, the version-up/addition accepting section 28 can accept the instructions from plural users. The instruction may be transmitted from a user via a communication device such as a portable terminal and received via the communication unit 16.

The dependency relation extracting section 30 extracts a dependent software with which the software subjected to the version-up processing or the addition processing has a dependency relation. The dependency relation indicates a relation that one software uses a part or all the algorithms of the other software.

The management information setting section 32 sets management information of the software as to which the version-up/addition accepting section 28 accepts the instruction of the version-up processing or the addition processing and the dependent software extracted by the dependency relation extracting section 30. The management information includes the version of the software, a reference value related to the software as information representing the progressing state of the version-up processing or the addition processing of the software, for example. The reference value is 0 or a positive integer, for example, but is not limited thereto.

The reference value changing section 34 increases the reference value (add 1 to the reference value, for example) in the case where the version-up processing or the addition processing is instructed as to the software subjected to the version-up processing or the addition processing or as to the dependent software having the dependency relation therewith, whilst decreases the reference value of the software subjected to the processing or the dependent software (reduce 1 from the reference value, for example) in the case where the stop of the version-up processing or the addition processing is instructed. When the version-up processing or the addition processing is completed, the reference value is changed to an initial value (0, for example).

The version-up/addition section 36 executes the version-up processing or the addition processing of the software based on the instruction of the version-up processing or the addition processing accepted by the version-up/addition accepting section 28.

The stop determination section 38 determines, at the time of accepting the stop instruction of the version-up processing or the addition processing, whether or not the stop instruction is to be executed based on the reference value. For example, supposing that the reference value is 0 or a positive integer and the initial value thereof is 0, when the reference value is 1 or more, it means that there is the version-up processing or the addition processing and the processing thereof has not been completed yet. In particular, in the case where another software has the dependency relation to one software subjected to the version-up processing or the addition processing, the one software necessary for the operation of the another software is required to continue the version-up processing or the addition processing for the another software even when the one software is not necessary for the version-up processing or the addition processing. This is applied to the following case. For example, after a user instructs the addition processing of one software and the reference value changing section 34 changes the reference value to 1 from 0, when another user instructs the addition processing of another software having the dependency relation with the one software, the dependency relation is extracted by the dependency relation extracting section 30 and the reference value changing section 34 changes the reference value of the one software to 2 from 1. In this state, when the one user inputs the stop instruction of the addition processing of the one software, for example (in this case, the reference value changing section 34 changes the reference value to 1 from 2), the stop determination section 38 refers to the reference value of the one software. In the case where the reference value is not 0, when the stop of the addition processing of the one software is instructed, the stop determination section 38 determines that the addition processing of the one software is still necessary due to the dependency relation to the another software even to thereby reject the execution of the stop instruction. On the other hand, in the case where the reference value is 0, the stop determination section 38 determines that there is not such a reason that the one software is still necessary for said another software and executes the stop instruction.

The notifying section 40 notifies to a user the extraction of a dependency software when the dependency relation extracting section 30 extracts the dependent software. This notification is performed by displaying the extraction on the display unit 20, for example. The contents of the notification is preferably the processing state of the version-up processing or the addition processing of the dependent software or an instruction to a user for promoting the version-up processing or the addition processing of the subject software, for example.

The communication control section 42 controls the communication of a software for the version-up or the addition of the software of the multifunction apparatus 100 or information such as the version-up or addition or stop of the software, performed by the communication unit 16, between the software providing server 104 or the portable terminal of a user and the software version-up/addition management apparatus.

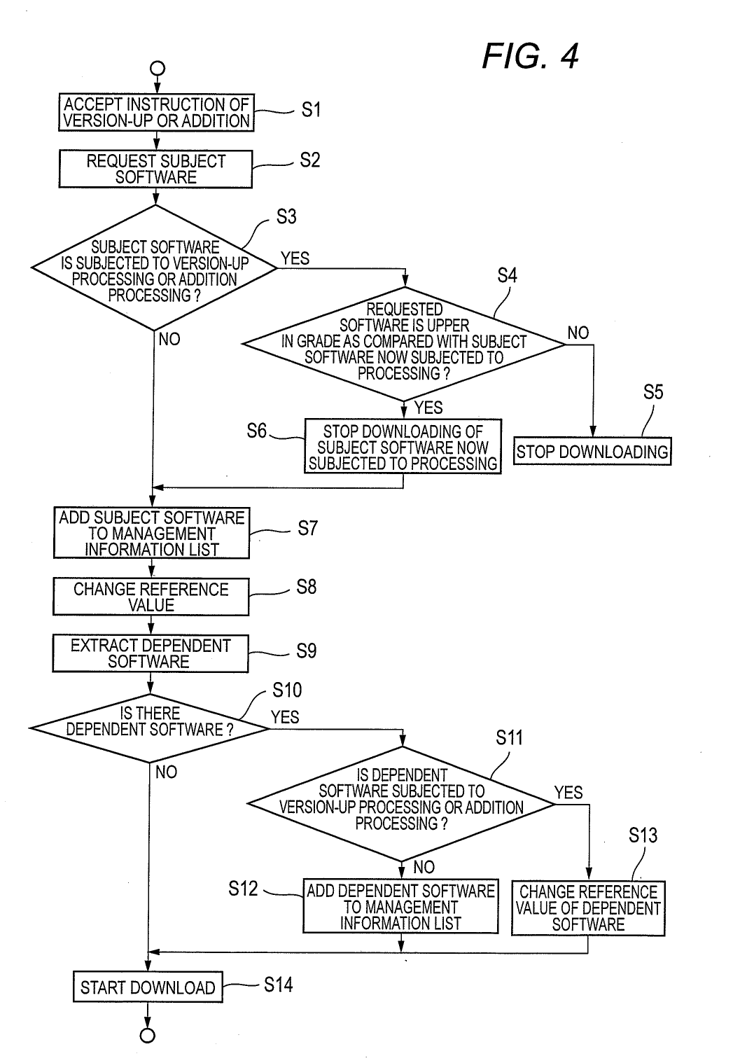

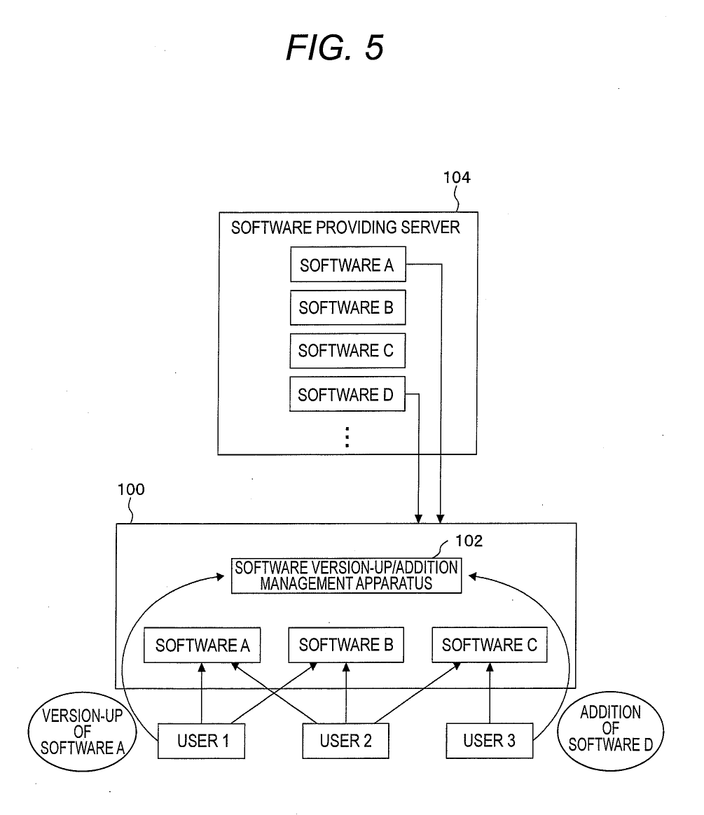

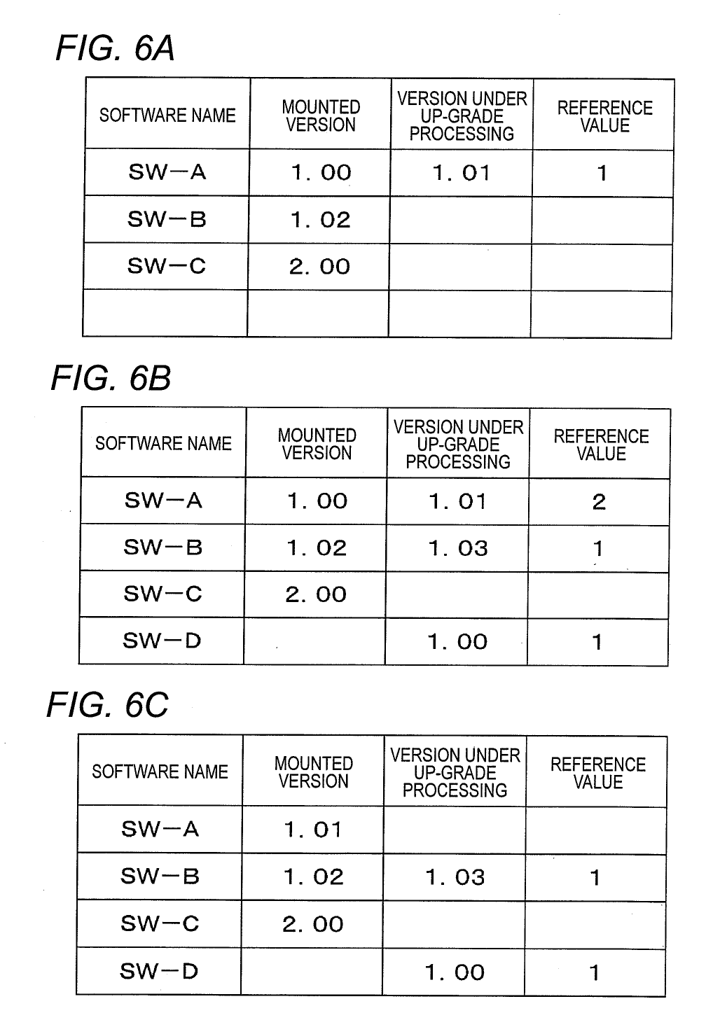

FIG. 4 is a flowchart showing an example of the operation of the software version-up/addition management apparatus 102 according to the exemplary embodiment. FIG. 5 is a diagram for explaining the flow of instructions and softwares in the case where a user instructs the version-up or addition of the software. FIGS. 6A to 6C show examples of management information lists managed by the software version-up/addition management apparatus 102 in the case where a user instructs the version-up or addition of a software. The management information setting section 32 sets the management information lists.

In FIG. 4, when the instruction of the version-up processing or the addition processing of a software is transmitted from the portable terminal etc. by a user, the version-up/addition accepting section 28 accepts the instruction (S1). The version-up/addition accepting section 28 selects a software to be subject to the version-up processing or the addition processing (hereinafter referred to a subject software) based on the instruction of the version-up processing or the addition processing thus accepted and requests the software providing server 104 as to the downloading or installation of the software via the communication control section 42 (S2).

To be concrete, for example, in FIG. 5, the multifunction apparatus 100 mounts a software A, a software B and a software C etc. and three users (user 1, user 2, user 3) use the multifunction apparatus 100. In this case, for example, the user 1 uses the software A and the software B, the user 2 uses the software A, the software B and the software C, and the user 3 uses the software C. The software providing server 104 can provide the software A, the software B, the software C, a software D etc. as a version-up or newly added software. In this state, for example, when the user 1 instructs the version-up of the software A to the software version-up/addition management apparatus 102, the version-up/addition accepting section 28 accepts this instruction and requests the new version of the software A to the software providing server 104.

Next, the version-up/addition accepting section 28 determines whether or not the subject software is now subjected to the version-up processing or the addition processing (now downloaded or installed from the software providing server 104) (S3). For example, when another user already instructs the version-up processing or the addition processing of the subject software, it is determined that the subject software is now subjected to the version-up processing or the addition processing. When the subject software is now subjected to the processing, the version of the subject software now subjected to the processing is compared with the version of the subject software (hereinafter referred to a requested software) requested in the step S2 to thereby determine whether or not the version of the requested software is new (upper in the grade) as compared with the version of the subject software now subjected to the processing (S4).

When it is determined in the step S4 that the version of the requested software is not new as compared with the version of the subject software now subjected to the processing, the downloading of the requested software is stopped (S5). On the other hand, when it is determined in the step S4 that the version of the requested software is new as compared with the version of the subject software now subjected to the processing, the downloading of the subject software now subjected to the processing is stopped (S6).

When it is determined that the subject software is not subjected to the processing in the step S3 or the downloading of the subject software now subjected to the processing is stopped in the step S6, the management information setting section 32 adds the requested software to the management information list as the subject software (S7). Further, the reference value changing section 34 changes the reference value of the subject software added to the management information list so as to represent that the subject software is now subjected to the version-up processing or the addition processing (S8).

To be concrete, for example, when the user 1 instructs the version-up of the software A, the new or up-grade version (1.01) of the software A is added to the column of the version under the up-grade processing within the management information list of a list format shown in FIG. 6A. The reference value changing section 34 sets 1 as the reference value of the software A to be up-graded. In the example shown in FIG. 6A, the version of the mounted software and the reference value are also shown. The blank space of the reference value column represents that the reference value is 0 (the software is not subjected to the version-up processing or the addition processing). The reference value is incremented by one each time the version-up processing or the addition processing is instructed, whilst decremented by one each time the version-up processing or the addition processing is stopped.

Next, the dependency relation extracting section 30 extracts the dependent software with respect to which the subject software has the dependency relation (S9). When the dependent software exists (is extracted in the step S9) (S10), the dependency relation extracting section 30 determines whether or not the dependent software is now subjected to the version-up processing or the addition processing (S11). When the dependent software is extracted, the notifying section 40 may notify the fact to a user.

When it is determined that the dependent software is not subjected to the version-up processing or the addition processing in the step S11, the management information setting section 32 adds the dependent software to the management information list and the reference value changing section 34 changes the reference value of the dependent software thus added to the management information list (S12). In contrast, when the dependent software is now subjected to the version-up processing or the addition processing, the reference value changing section 34 changes the reference value of the dependent software already added to the management information list (S13).

To be concrete, for example, in FIG. 5, when the user 3 instructs the addition of the software D to the software version-up/addition management apparatus 102, the version-up/addition accepting section 28 accepts this instruction and requests the software D to the software providing server 104. In this case, when the software A and the software B are extracted as the dependent softwares, the management information setting section 32 adds the version (1.00) of the software D to the management information list, and the reference value changing section 34 changes the reference value of the software A to 2 and each of the reference values of the software B and the software D to 1, as shown in FIG. 6B. Although the reference value of the software A is 1 at the stage of FIG. 6A (instruction of the version-up processing), since the this software is extracted as the dependent software of the software D and so required to be subjected to the version-up processing as the dependent software, the reference value thereof is incremented by one and so becomes 2.

At the time of accepting the instruction of the stop of the version-up processing or the addition processing from a user, the stop determination section 38 refers the reference value and stops the version-up processing or the addition processing only when the reference value is 0. For example, when the user 1 instructs the stop of the version-up processing of the software A in the state of FIG. 6B, the reference value changing section 34 reduces 1 from the reference value of the software A and so the reference value becomes 1. In this case, since the reference value of the software A is not 0 (1 in this case), the stop determination section 38 does not execute the stop of the version-up processing. This is because although the version-up processing of the software A is not necessary for the user A, the version-up processing of the software A is necessary for the software D which is instructed to be added by the user 3. In this manner, when the reference value is not 0, although the processing of the software corresponding to this reference value becomes not necessary for a user who already instructed the version-up processing or the addition processing, the software corresponding to this reference value is still necessary for the software as a subject to the version-up processing or the addition processing instructed by another user. Thus, the stop determination section 38 determines that the stop of the version-up processing or the addition processing is not executed.

When it is determined that the dependent software does not exist in the step S10, the version-up/addition section 36 executes the version-up processing or the addition processing of the subject software accepted in the step S1. In contrast, when it is determined that the dependent software exists in the step S10, the version-up/addition section 36 executes the version-up processing or the addition processing (downloading) of each of the subject software and the dependent software (S14). In this case, the order of the downloading processings of the subject software and the dependent software is not limited and the downloading processings thereof may be performed simultaneously.

FIG. 6C shows an example of the management information list when the version-up/addition section 36 completes the version-up processing of the software A. In FIG. 6C, the reference value of the software A is set to 0 due to the completion of the version-up processing. The reference value of the software B is kept to 1 since the version-up processing of the software B has not completed yet. Also the reference value of the software D is kept to 1 since the addition processing thereof has not completed yet.

The program for executing the respective steps of FIG. 4 may be stored in a recording medium or provided by communications. In this case, the program explained above may be interpreted as the invention of “a computer readable recording medium recording program therein” or the invention of “a data signal”.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A software version-up/addition managing apparatus, comprising:
a version-up/addition accepting section that accepts an instruction of version-up processing or addition processing of a software;
a dependency relation extracting section that extracts a dependent software with which the software to be subjected to the version-up processing or the addition processing has a dependency relation;
a reference value associating section that associates reference values with (i) the software of which the version-up/addition accepting section accepts the instruction of the version-up processing or the addition processing, and (ii) the dependent software extracted by the dependency relation extracting section, respectively;
a reference value changing section that,
when the version-up processing or the addition processing is instructed as to the software or the dependent software or when the software or the dependent software is extracted as a dependent software of another software,
increments the reference value of the software to be subjected to the version-up processing or the addition processing or the dependent software extracted by the dependency relation extracting section, and
when stop of the version-up processing or the addition processing is instructed,
decrements the reference value of the software to be subjected to the version-up processing or the addition processing or the dependent software extracted by the dependency relation extracting section; and
a stop determination section that determines based on the reference value, when the instruction of the stop of the version-up processing or the addition processing is accepted, whether or not the instruction of the stop is to be executed.

2. The software version-up/addition managing apparatus according to claim 1,
wherein the version-up/addition accepting section rejects acceptance of the version-up processing or the addition processing of the software which version is not new as compared with a version of the software being subjected to the version-up processing or the addition processing.

3. The software version-up/addition managing apparatus according to claim 1, further comprising:
a notifying section that notifies, when the dependency relation extracting section extracts the dependent software, a processing state of the version-up processing or the addition processing of the dependent software or the instruction of the version-up processing or the addition processing of the dependent software.

4. A multifunction apparatus, comprising:
the software version-up/addition managing apparatus according to claim 1; and
the software that is subjected to the version-up processing or the addition processing by the software version-up/addition managing apparatus.

5. A software version-up/addition managing method comprising:
accepting an instruction of version-up processing or addition processing of a software;
extracting a dependent software with which the software to be subjected to the version-up processing or the addition processing has a dependency relation;
associating reference values with (i) the software of which the accepting step accepts the instruction of the version-up processing or the addition processing, and (ii) the dependent software extracted by the extracting step, respectively;
incrementing when the version-up processing or the addition processing is instructed as to the software or the dependent software or when the software or the dependent software is extracted as a dependent software of another software, the reference value of the software to be subjected to the version-up processing or the addition processing or the dependent software extracted by the extracting step; and
decrementing when stop of the version-up processing or the addition processing is instructed, the reference value of the software to be subjected to the version-up processing or the addition processing or the dependent software extracted by the extracting step; and
determining based on the reference value, when the instruction of the stop of the version-up processing or the addition processing is accepted, whether or not the instruction of the stop is to be executed.

6. A computer readable medium storing a program causing a computer to execute a process for a software version-up/addition management, the process comprising:
accepting an instruction of version-up processing or addition processing of a software;
extracting a dependent software with which the software to be subjected to the version-up processing or the addition processing has a dependency relation;
associating reference values with (i) the software of which the accepting step accepts the instruction of the version-up processing or the addition processing, and (ii) the dependent software extracted by the extracting step, respectively;
incrementing when the version-up processing or the addition processing is instructed as to the software or the dependent software or when the software or the dependent software is extracted as a dependent software of another software, the reference value of the software to be subjected to the version-up processing or the addition processing or the dependent software extracted by the extracting step; and
decrementing when stop of the version-up processing or the addition processing is instructed, the reference value of the software to be subjected to the version-up processing or the addition processing or the dependent software extracted by the extracting step; and
determining based on the reference value, when the instruction of the stop of the version-up processing or the addition processing is accepted, whether or not the instruction of the stop is to be executed.
